(19) United States
(12) Patent Application Publication
(10) Pub. No.: US 2020/0011728 A1
(43) Pub. Date: Jan. 9, 2020

(54) FISH LOGGING DEVICE AND DATA SYSTEM

(71) Applicant: Joseph Ganahl, Honolulu, HI (US)

(72) Inventor: Joseph Ganahl, Honolulu, HI (US)

(21) Appl. No.: 16/029,596

(22) Filed: Jul. 8, 2018

(51) Int. Cl. G01G 19/18; G01S 19/13; G01B 7/02; G01G 23/37; G06K 9/00; G06F 17/30

(52) U.S. Cl. CPC G01G 19/18; G01S 19/13; G01B 7/026; G06F 17/30312; G06K 9/00664; G06K 9/00369; G01G 23/3742

(57) ABSTRACT

The embodiments disclose a fish logging device configured to gather data on a fish caught by a user using a digital tape measure, a digital weight scale and a digital memory device coupled to the fish logging device apparatus, a safety fish lip gripper with serrated gripping jaws and a safety fish lip gripper finger grip activator coupled to the fish logging device apparatus for securing a fish to the fish logging device apparatus, a one touch selfie button coupled to the fish logging device to activate a user smart phone to take a photo of the fish caught, a fish logging device application installed on a user smart phone to download gathered data from the fish logging device apparatus digital memory device and upload and download the gathered data with a fish logging device server cloud and a fish logging device server cloud for gathering data about fishing including data on a fish caught by a user and configured to interactively upload and download data with the fish logging device application installed on a user smart phone.

### BACKGROUND

Fishing is a sport and a method of gathering food. Persons who fish have a natural curiosity on how big the one that did not get away is and like to share that information with friends and family. Fishing information on where to fish, what bait to use to catch a type of fish, and other information used to determine when, where and what other conditions and materials to increase the chances of catching fish. However, generally that information is passed by word of mouth from one fisher to another.

### BRIEF DESCRIPTION OF THE DRAWINGS

FIG. 1 shows for illustrative purposes only an example of a fish logging device front view of one embodiment.

FIG. 2A shows for illustrative purposes only an example of a fish logging device back view of one embodiment.

FIG. 2B shows for illustrative purposes only an example of fish logging device serrated gripping jaws of one embodiment.

FIG. 3 shows for illustrative purposes only an example of a fish logging device left side view of one embodiment.

FIG. 4 shows for illustrative purposes only an example of a fish logging device right side view of one embodiment.

FIG. 5A shows for illustrative purposes only an example of an overview flow chart of fish logging device method and apparatuses of one embodiment.

FIG. 5B shows for illustrative purposes only an example of a fish logging device tape measure process of one embodiment.

FIG. 6 shows for illustrative purposes only an example of a fish logging device apparatus of one embodiment.

FIG. 7 shows for illustrative purposes only an example of a fish logging device application installed on user smart phone of one embodiment.

FIG. 8 shows for illustrative purposes only an example of a fish logging device server cloud of one embodiment.

FIG. 9 shows for illustrative purposes only an example of safety fish lip gripper finger grip activator opening process of one embodiment.

FIG. 10 shows for illustrative purposes only an example of safety fish lip gripper finger grip activator closing process of one embodiment.

FIG. 11 shows for illustrative purposes only an example of safety fish lip gripper finger grip activator closed on a fish of one embodiment.

FIG. 12 shows for illustrative purposes only an example of another embodiment of a fish logging device back view of one embodiment.

FIG. 13 shows for illustrative purposes only an example of another embodiment of a fish logging device back interior view of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Working Example

It should be noted that the descriptions that follow, for example, in terms of a fish logging device and data system is described for illustrative purposes and the underlying system can apply to any number and multiple types fishing scenarios. In one embodiment of the present invention, the fish logging device and data system can be configured using a fish logging device apparatus. The fish logging device and data system can be configured to include a fish logging device application to be installed on a user smart phone and can be configured to include a fish logging device server cloud for data communications with the user smart phone using the embodiments.

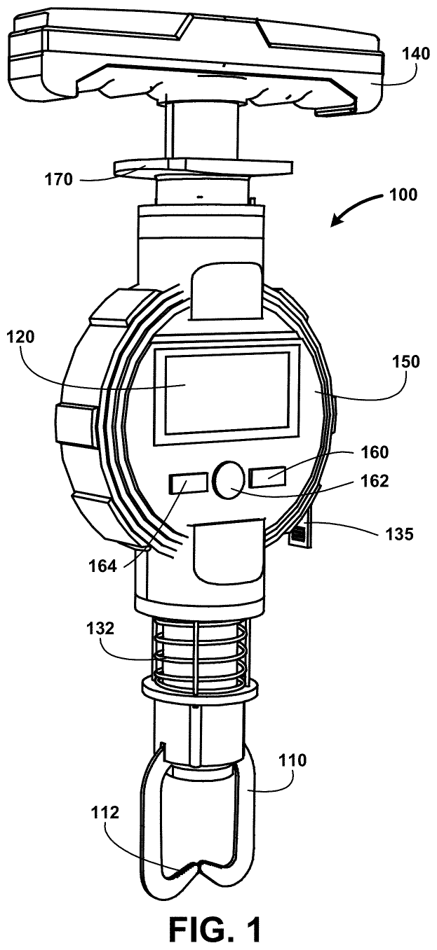

FIG. 1 shows for illustrative purposes only an example of a fish logging device front view of one embodiment. FIG. 1 shows a fish logging device 100 apparatus with a safety fish lip gripper 110, data display screen 120, digital weight scale, handle 140, floatable case 150, and control buttons including a menu selection button 160, on-off button 162, data selection button 164 and a safety fish lip gripper open/close pull lever 170. The fish logging device 100 apparatus stores weight and length data of up to 10 fish on a digital memory device.

A user smart phone with a fish logging device application can download the stored data on the digital memory device. When a person catches a fish they can couple the fish to the safety fish lip gripper 110 to weigh the fish caught using the digital weight scale while holding the fish logging device 100 by the handle 140. The weight and digitally measured length of the fish is displayed on the data display screen 120. Should the user drop the fish logging device 100 apparatus in the water it will float using the floatable case 150.

The data display screen 120 and control buttons are waterproofed to prevent any damage. The user can retrieve the fish logging device 100 apparatus from the water without damage. A digital measuring tape pull tab 135 is used to extend the tape with a fish held in the safety fish lip gripper 110 to extend digital measuring tape which records the measured length of the fish on a digital memory device of one embodiment.

### Serrated Gripping Jaws:

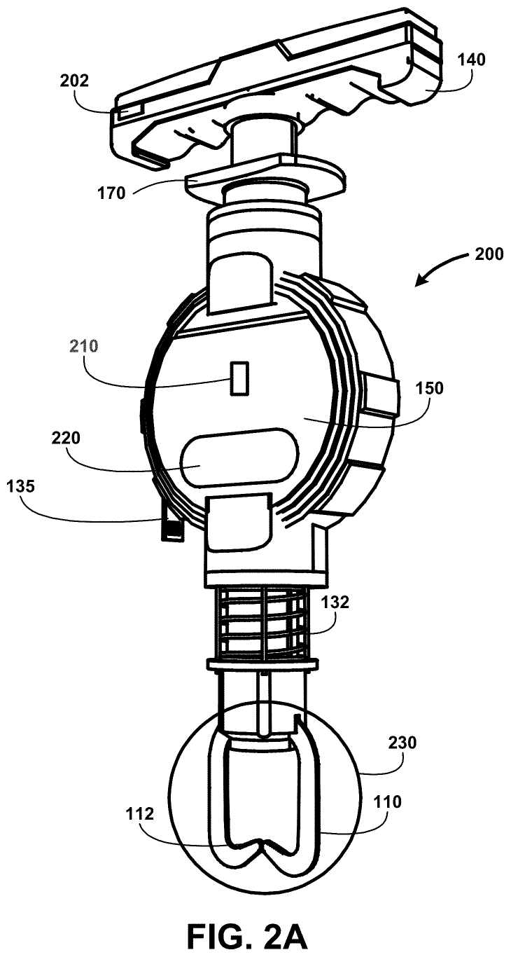

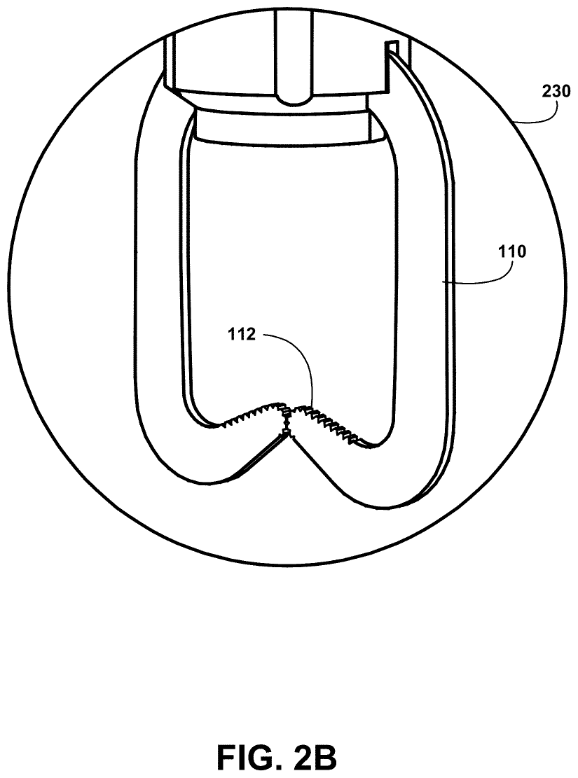

FIG. 2A shows for illustrative purposes only an example of a fish logging device back view of one embodiment. FIG. 2A shows a fish logging device back view 200 including the safety fish lip gripper 110, serrated gripping jaws 112, floatable case 150, weight scale, one touch selfie button 202, digital measuring tape retraction button 210, waterproof rechargeable battery pack 220, handle 140 and one embodiment of a safety fish lip gripper open/close lever 170. The waterproof rechargeable battery pack 220 is installed in a waterproof compartment. The user can push the one touch selfie button 202 with a finger or thumb while holding the handle for example while weighing the fish. The one touch selfie button 202 transmits a signal to the user smart phone to activate the user smart phone camera to take a photo to capture an image of the fish and upload fish data of weight and length to the user smart phone of the fish displayed on the data display screen 120 of FIG. 1 of one embodiment. A detailed view of the safety fish lip gripper 230 is shown in FIG. 2B.

FIG. 2B shows for illustrative purposes only an example of fish logging device serrated gripping jaws of one embodiment. FIG. 2B shows a safety fish lip gripper detailed view 230 of the serrated gripping jaws 112 of the safety fish lip gripper 110. The serrated gripping jaws 112 prevent a fish from slipping from the safety fish lip gripper 110 when being held, weighed or measured of one embodiment.

### A Fish Logging Device Left Side View:

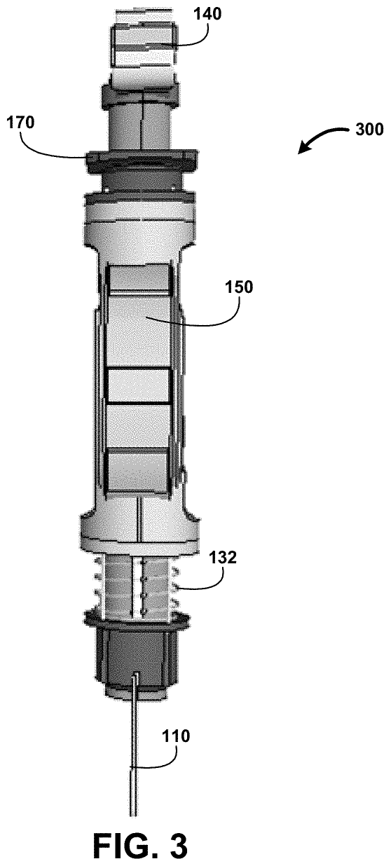

FIG. 3 shows for illustrative purposes only an example of a fish logging device left side view of one embodiment. FIG. 3 shows a fish logging device left side view 300 showing the handle 140, floatable case 150, safety fish lip gripper 110, safety fish lip gripper spring 132, and safety fish lip gripper open/close lever 170 side view of one embodiment.

### A Fish Logging Device Right Side View:

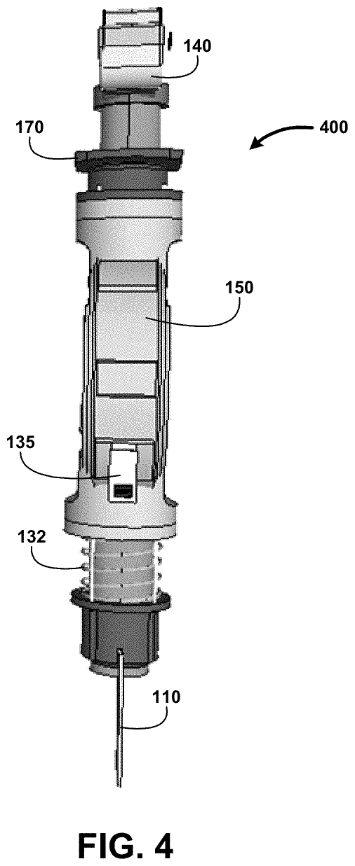

FIG. 4 shows for illustrative purposes only an example of a fish logging device right side view of one embodiment. FIG. 4 shows a fish logging device right side view 400 showing the safety fish lip gripper 110, handle 140, floatable case 150, safety fish lip gripper spring 132, safety fish lip gripper open/close lever 170 side view, and the digital measuring tape pull tab 135 of one embodiment.

### A Fish Logging Device Method and Apparatuses:

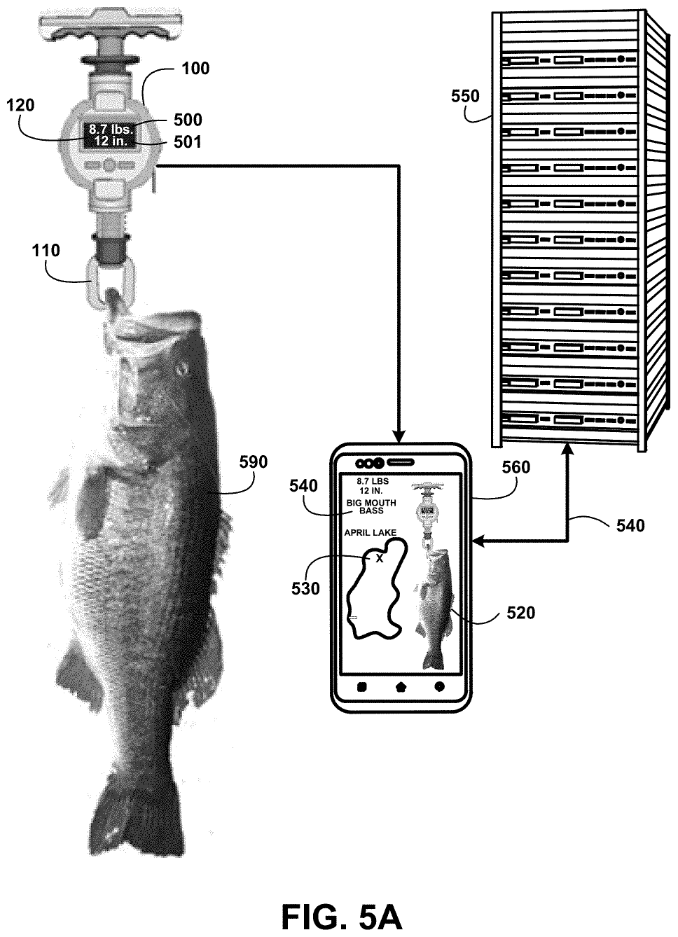

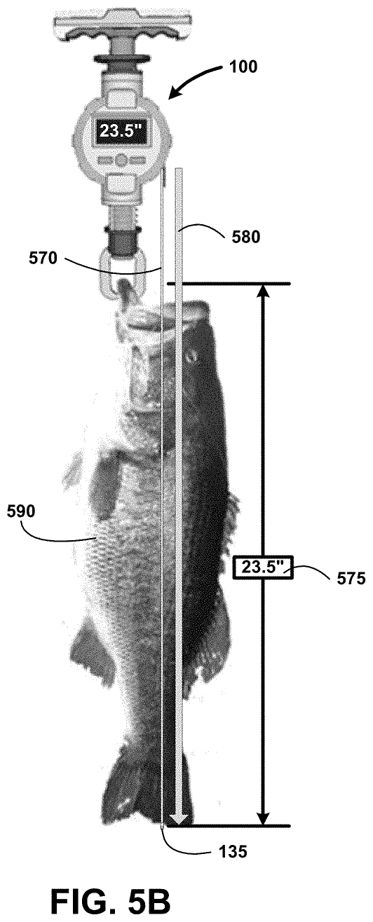

FIG. 5A shows for illustrative purposes only an example of an overview flow chart of a fish logging device method and apparatuses of one embodiment. FIG. 5A shows coupling a fish caught 590 to the safety fish lip gripper 110 and the fish logging device 100 being used for weighing fish on the weight scale and storing weight data on fish logging device digital memory device.

The weight of the fish in this example is 8.7 lbs. 500 and length is 12 in. 501 and the weight and length is displaying on the data display screen 120. The fish logging device 100 is used by the user for activating the one touch selfie button 202 of FIG. 2A for capturing a photo of the fish 520 on a user smart phone. The one touch selfie button 202 of FIG. 2A using a near-field transceiver triggers the camera of the user smart phone to snap a photo. The photo image of the fish caught 590 is recorded on the user smart phone 560.

A user smart phone 560 with a fish logging device application installed can be used for locating the catch site using fish logging device application on user smart phone GPS location function 530 to capture the GPS location and displaying an “X” overlay on a map showing the physical location corresponding to the GPS location. The user smart phone 560 with a fish logging device application installed in communication with a fish logging device server cloud 550 using an internet connection can be used for identifying fish species using the photo and fish species data base in fish logging device server 540 of one embodiment.

A smart phone application electronically connected to the fish logging device can be used to collect all data from the fish logging device digital memory device. This collected data can then be manipulated, analyzed and processed and appropriately configured in a user desired manner for easy remote access or cloud-based for storage. This will allow easy and straightforward social media storage, manipulation and sharing.

### Fish Lowing Device Tape Measure Process:

FIG. 5B shows for illustrative purposes only an example of a fish logging device tape measure process of one embodiment. FIG. 5B shows the fish logging device 100 apparatus and coupling a fish caught 590 to the safety fish lip gripper 110 of FIG. 1.

A user can extend the digital measuring tape 570 by pulling 580 on the digital measuring tape pull tab 135 to the tail of the fish. The user can then read the length measured on the data display screen 120 of FIG. 1 and the digital fish length measurement is recorded on the digital memory device, in this example 22.5″ 575 of one embodiment.

### A Fish Lowing Device Apparatus:

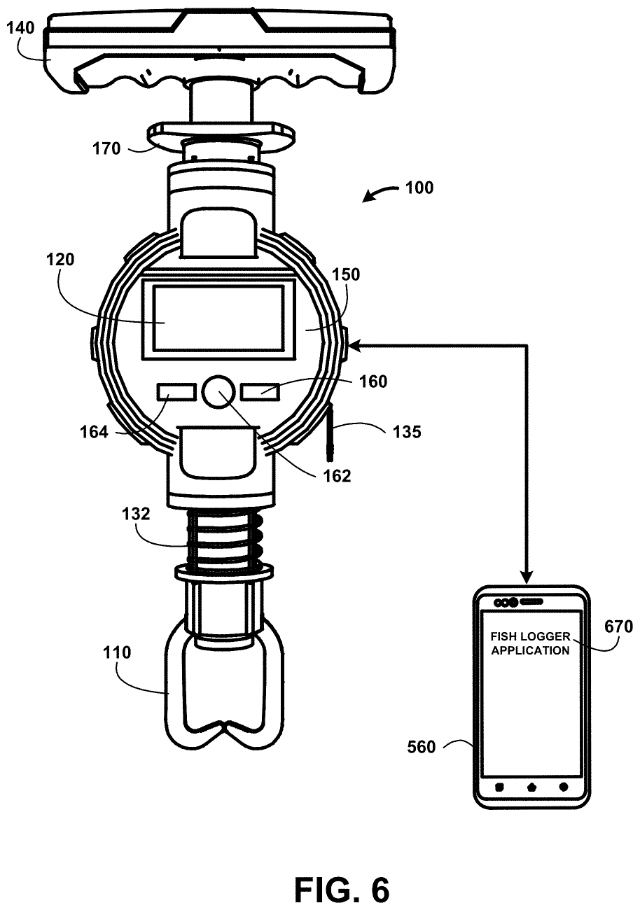

FIG. 6 shows for illustrative purposes only an example of a fish logging device apparatus of one embodiment. FIG. 6 shows the fish logging device 100 front view configured to include a weight scale, safety fish lip gripper 110, floatable case 150, data display screen 120, waterproof rechargeable battery pack, menu selection button 160, on-off button 162, data selection button 164, and one embodiment of a safety fish lip gripper open/close lever 170. The one touch selfie button 202 of FIG. 2A automatically triggers a user smart phone camera photo image capture.

The user smart camera phone photo image capture is used for example for a digital tape measure process of the fish caught 590 of FIG. 5A. The fish logging device 100 apparatus includes a digital processor and a digital memory device and can store 10 weights of a number of fish caught. The fish logging device 100 apparatus includes a near-field transceiver and a fish logging device application installed on a user smart phone with a fish logging device application installed 670 can upload from the digital memory device using the near-field transceiver the stored data on fishes caught of one embodiment.

### A Fish Lowing Device Application Installed on User Smart Phone:

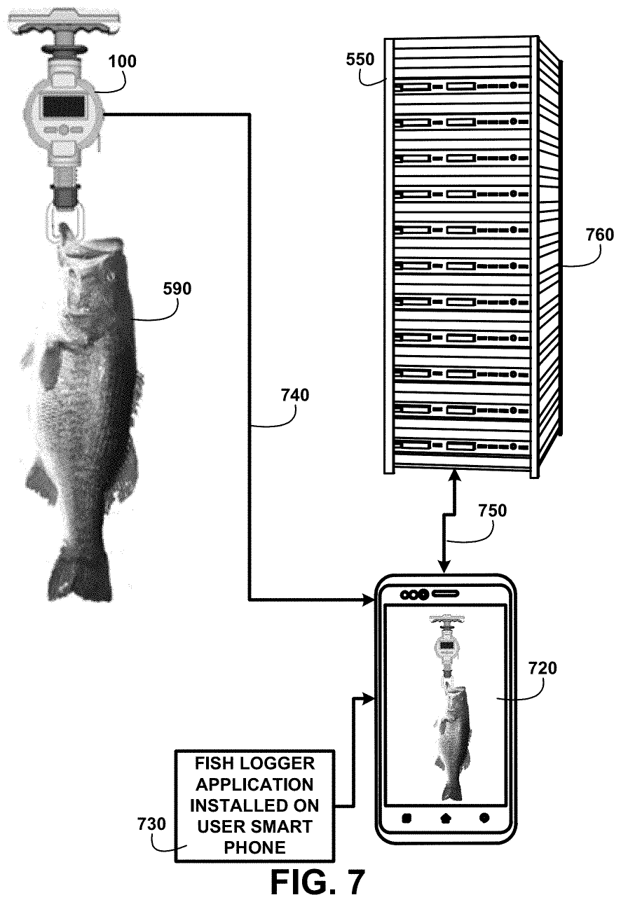

FIG. 7 shows for illustrative purposes only an example of a fish logging device application installed on user smart phone of one embodiment. FIG. 7 shows the fish logging device 100 and the caught fish 590 coupled to the safety fish lip gripper 110. The caught fish data downloaded to and captured using the fish logging device application 740 can include for example the weight and length of the caught fish 590, date of the catch, and GPS coordinates location.

A fish logging device application installed on the user smart phone 730 can be used for the capture of a photo of the caught fish 590 activated using the one touch selfie button 202 of FIG. 2A and for displaying fish logging device selfie photo 720. The fish logging device application installed on the user smart phone 730 can be used for uploading data to the fish logging device server cloud 750. The fish logging device application installed on the user smart phone 730 can receive data from a database of a fish logging device server cloud 760 including identifying fish species using photo and a fish species database in a fish logging device server 540 of FIG. 5A of one embodiment.

### A Fish Logging Device Server Cloud:

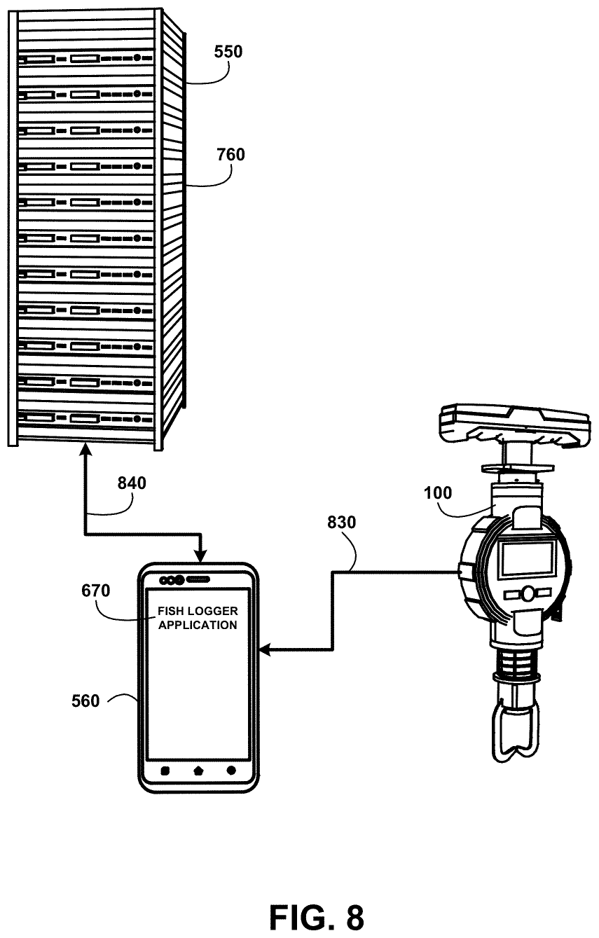

FIG. 8 shows for illustrative purposes only an example of a fish logging device server cloud of one embodiment. FIG. 8 shows the fish logging device server cloud 550 with digital processors, digital memory devices, WIFI internet communication devices, a database of fish species including images and a database of fish size records automatically updated. The digital processors can be used to automatically determine a percentage of a record size for a fish caught by a user.

The fish logging device server cloud 550 can automatically list baits used from other catches reported on the user smart phone with fish logging device application installed 670 to assist the user in fishing. The fish logging device server cloud 550 can process automatic fish species identification from a photo of a fish caught. The fish logging device server cloud 550 automatically updates and stores for retrieval a database with phase of moon, barometric pressure conditions, sunny/cloudy/overcast forecasts, route maps to fishing locations, locations of where fish have been caught, and time of catch. The fish logging device server cloud 760 includes a database with type of fish, bait used, and depth of water as additional data points.

Data is auto searched and loaded to the fish logging device server cloud and data can be filtered for retrieval by date, weight, fish type, and location. The fish logging device server cloud 760 includes a database with nearby fishing locations which can be displayed on the user smart phone 560 with fish logging device application installed 670 using a search by the user and/or automatically based on the user smart phone current GPS location. Data from the fish logging device 100 can be downloaded 830 using the user smart phone with fish logging device application installed 670. Data including for example current fish catches can be automatically uploaded and downloaded using an interactive data flow between the fish logging device server cloud and the user smart phone with fish logging device application installed 840 of one embodiment.

### Safety Fish Lip Gripper Finger Grip Activator Opening Process:

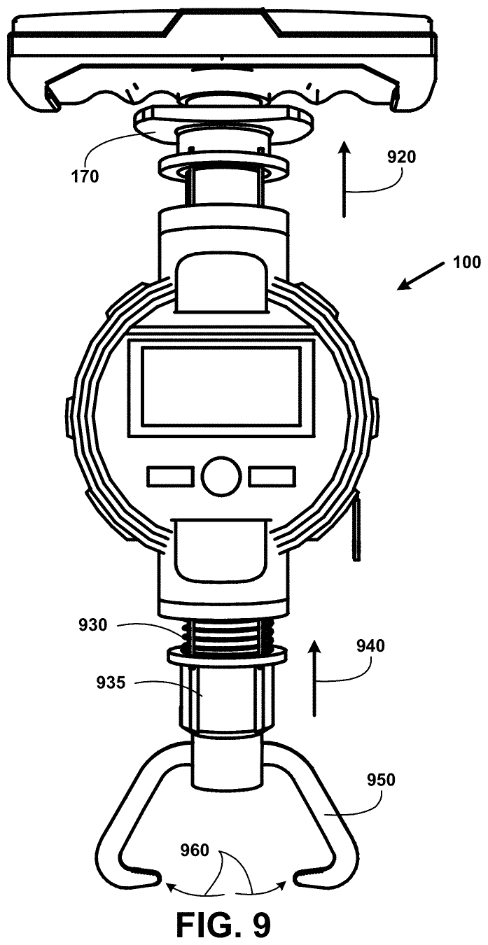

FIG. 9 shows for illustrative purposes only an example of safety fish lip gripper finger grip activator opening process of one embodiment. FIG. 9 shows the fish logging device apparatus 100 with a safety fish lip gripper finger grip activator 170. The safety fish lip gripper finger grip activator 170 can be operated by a user using a safety fish lip gripper finger grip activator pulling process 920. The safety fish lip gripper finger grip activator pulling process 920 begins with the user placing one or more digits to grasp the safety fish lip gripper finger grip activator 170 then pulling the activator toward the another embodiment of the fish logging device apparatus 100 handle. This action pulls a shaft coupled to a safety fish lip gripper finger grip activator coupler 935.

The safety fish lip gripper finger grip activator coupler 935 pulls against a safety fish lip gripper finger grip activator spring 930 in a safety fish lip gripper finger grip activator spring compression process 940. The safety fish lip gripper finger grip activator coupler 935 is coupled to two terminating ends of the two fish lip grippers. The two fish lip grippers are caused to pivot on pins (not shown) in a safety fish lip gripper finger grip activator opening process 960. At the end of the safety fish lip gripper finger grip activator opening process 960 the two fish lip grippers are in a safety fish lip gripper opened position 950 of one embodiment.

### Safety Fish Lip Gripper Finger Grip Activator Closing Process:

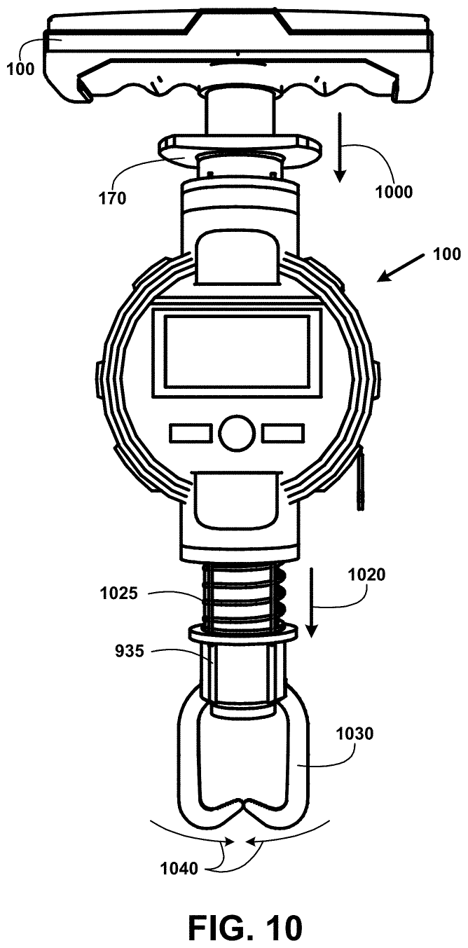

FIG. 10 shows for illustrative purposes only an example of safety fish lip gripper finger grip activator closing process of one embodiment. FIG. 10 shows the fish logging device apparatus 100 and safety fish lip gripper finger grip activator 170. A safety fish lip gripper finger grip activator release process 1000 begins with the user easing the pulling action to create a safety fish lip gripper finger grip activator spring rebound process 1020.

The safety fish lip gripper finger grip activator spring rebound process 1020 provides force from the rebounding safety fish lip gripper finger grip activator spring 1025 to push the against the safety fish lip gripper finger grip activator coupler 935 to create a safety fish lip gripper finger grip activator closing process 1040. The rebounding push against the safety fish lip gripper finger grip activator coupler 935 applies force to the two terminating ends of the two fish lip grippers which pivot on pins (not shown) to result in the two fish lip grippers return to a safety fish lip gripper closed position 1030 of one embodiment.

### Safety Fish Lip Gripper Finger Grip Activator Closed on a Fish:

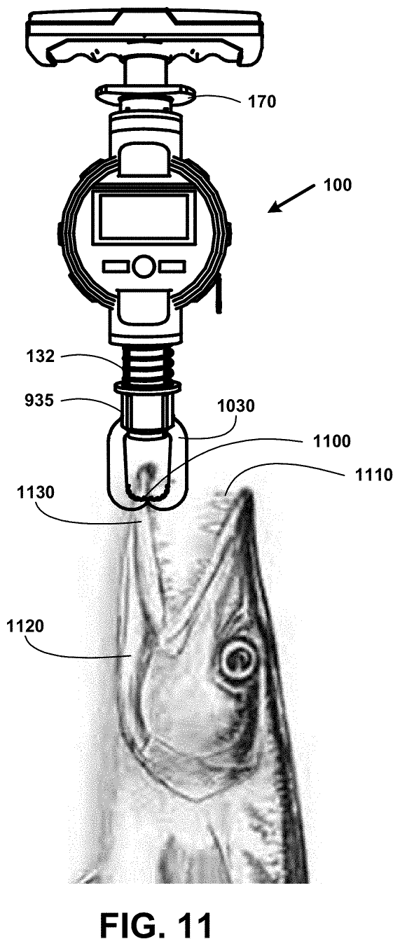

FIG. 11 shows for illustrative purposes only an example of safety fish lip gripper finger grip activator closed on a fish of one embodiment. FIG. 11 shows another embodiment of the fish logging device apparatus 100 with the safety fish lip gripper finger grip activator 170, safety fish lip gripper finger grip activator spring 132 and safety fish lip gripper finger grip activator coupler 935. The user may place a fish's lip into position against one of the safety fish lip gripper hook points while in an opened position. The user can do so without placing any fingers or other parts of their extremities in the fish's mouth.

The safety fish lip gripper finger grip activator closing process 1040 of FIG. 10 forces the closing of the safety fish lip gripper hooks 1100 upon the fish lip 1130 to hold the fish securely in the fish logging device apparatus 100. The fish logging device apparatus 100 safety fish lip gripper capability of opening and closing without exposing a user's fingers or other extremities prevents a user from injury. In one example the user could catch a barracuda 1120 or other fish species which has dangerous fish teeth 1110 that could lacerate one or more fingers and other hand areas. The safety fish lip gripper finger grip activator opening process 960 of FIG. 9 can be used to open the mouth of the fish without using fingers. The release of the safety fish lip gripper finger grip activator 170 placing the safety fish lip gripper hooks 1100 in a safety fish lip gripper closed position 1030 can then securely grip the fish lip 1130 without exposing user to the dangerous fish teeth 1110 of one embodiment.

### Another Embodiment of a Fish Logging Device Back View:

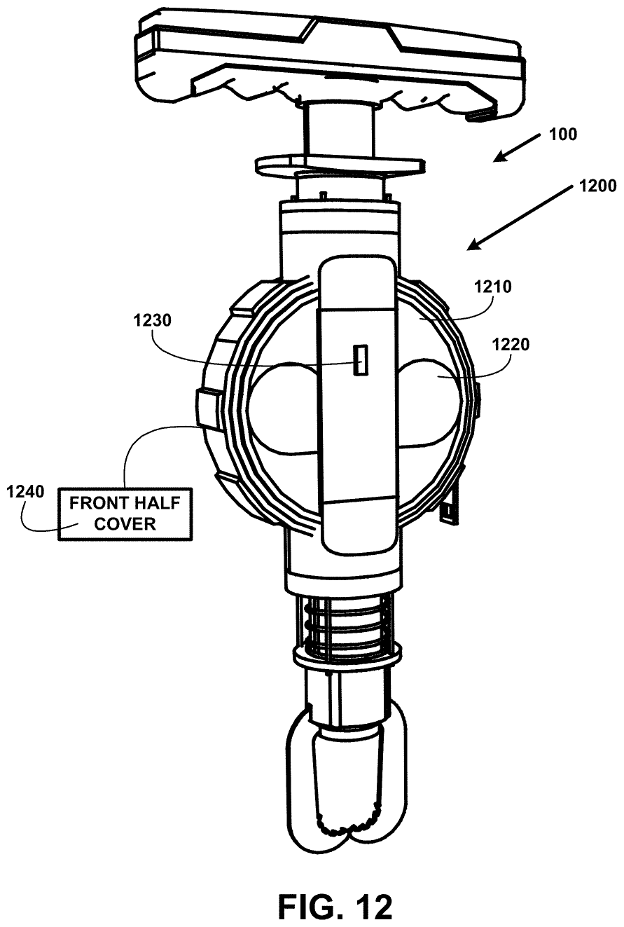

FIG. 12 shows for illustrative purposes only an example of another embodiment of a fish logging device back view of one embodiment. FIG. 12 shows another embodiment of a fish logging device back view 1200 of the fish logging device apparatus 100. A front half cover 1240 can be seen while a back half cover removed for illustration purposes allows a view of the digital tape measure retraction button 1230, interior back protector cover 1210 and battery compartment cover 1220 of one embodiment.

### Another Embodiment of a Fish Lowing Device Back Interior View:

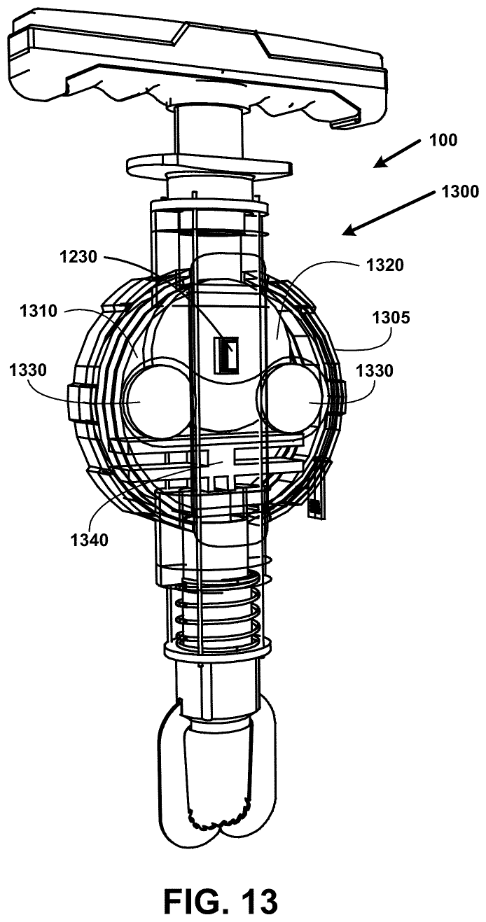

FIG. 13 shows for illustrative purposes only an example of another embodiment of a fish logging device back interior view of one embodiment. FIG. 13 shows a back half cover shown transparent 1305 for illustration purposes for another embodiment of the fish logging device apparatus 100 back interior view 1300. FIG. 13 shows the digital tape measure retraction button 1230 and a transparent battery compartment cover 1310. Showing are at least two battery 1330 installations, a digital tape measure compartment 1320 and a fish weight scale device 1340 of one embodiment.

In one embodiment, a method includes using a fish logging device apparatus with a digital tape measure, digital weight scale and a digital memory device for gathering data on a fish caught by a user and for storing the gathered data on the digital memory device, displaying the gathered data on a fish logging device apparatus data display screen, using a fish logging device apparatus safety fish lip gripper with serrated gripping jaws and a safety fish lip gripper finger grip activator for securing the fish to the fish logging device apparatus.

In addition, the method further includes activating a fish logging device apparatus selfie button for triggering a fish logging device application installed on a user smart phone for operating the user smart phone camera for capturing a photo of the fish, and downloading the gathered data using the fish logging device application and uploading the gathered data including the user smart phone fish logging device application gathered data to a fish logging device server cloud for storing, processing and downloading the gathered data. Gathering data on a fish caught by a user includes a weight using the digital weight scale and a length of the fish using the digital tape measure.

Also included is a near-field transceiver coupled to the fish logging device apparatus configured for transmitting a signal when activated using the fish logging device apparatus selfie button for triggering the user smart phone camera. Wherein gathering data on a fish caught by a user includes using the fish logging device application installed on user smart phone to capture a GPS location of where the fish was caught. Further, included is a digital server for creating the fish logging device server cloud configured for uploading and downloading the gathered data from and to the user smart phone fish logging device application. The fish logging device server cloud includes a database of fish species for processing the photo of the fish for automatically identifying the fish species and for downloading the fish species data to the fish logging device application.

They fish logging device can also include using the user smart phone fish logging device application for downloading the gathered data for sharing the gathered data with friends and family on social media. In another embodiment, the device is configured for uploading and downloading data interactively between the fish logging device application installed on user smart phone and the fish logging device server cloud wherein the fish logging device server cloud is automatically updating and storing for retrieval a database with phase of moon, barometric pressure conditions, sunny/cloudy/overcast forecasts, route maps to fishing locations, locations of where fish have been caught, and time of catch and transmitting requested data by a user using the fish logging device application.

In another embodiment, the device is configured for uploading and downloading data interactively between the fish logging device application installed on user smart phone and the fish logging device server cloud wherein the fish logging device server cloud includes a database with type of fish, bait used, and depth of water and wherein data is auto searched and loaded to the fish logging device server cloud and data can be filtered for retrieval by date, weight, fish type, and location using the fish logging device application.

In another embodiment, the device is configured for uploading and downloading data interactively between the fish logging device application installed on user smart phone and the fish logging device server cloud wherein the fish logging device server cloud includes a database with nearby fishing locations for transmitting nearby fishing locations automatically based on the user smart phone current GPS location to the user including displaying locations on the user smart phone for performing a search of nearby fishing locations for an area entered by the user on the user smart phone.

In another embodiment an apparatus includes a fish logging device apparatus configured to gather data on a fish caught by a user using a digital tape measure, a digital weight scale and a digital memory device coupled to the fish logging device apparatus, a safety fish lip gripper with serrated gripping jaws and a safety fish lip gripper finger grip activator coupled to the fish logging device apparatus to secure a fish to the fish logging device apparatus, a one touch selfie button coupled to the fish logging device apparatus to activate a user smart phone to take a photo of the fish caught, a fish logging device application installed on a user smart phone to download gathered data from the fish logging device apparatus digital memory device and upload and download the gathered data with a fish logging device server cloud, and a fish logging device server cloud to gather data about fishing including data on a fish caught by a user and configured to interactively upload and download data with the fish logging device application installed on a user smart phone.

In another embodiment, the device includes a data display screen, handle, floatable case, and control buttons coupled to the fish logging device apparatus. The fish logging device apparatus is configured for using the one touch selfie button to activate the fish logging device application installed on a user smart phone to trigger a camera to take a photo of the fish and weight and length of the fish displayed on the data display screen.

In another embodiment, the fish logging device server cloud is configured for processing an uploaded photo of the fish using the fish logging device application installed on user smart phone to identify the fish species of a fish caught using a fish species database on the fish logging device server cloud. In another embodiment, the fish logging device server cloud is configured for uploading and downloading data interactively between the fish logging device application installed on user smart phone wherein the fish logging device server cloud includes a database with nearby fishing locations for transmitting nearby fishing locations automatically based on a user smart phone current GPS location to the user including displaying locations on the user smart phone with fish logging device application installed and for performing a search of nearby fishing locations for an area entered by the user on the user smart phone.

In yet another embodiment an apparatus includes a fish logging device apparatus with a safety fish lip gripper with serrated gripping jaws and a safety fish lip gripper finger grip activator to secure a fish to the fish logging device apparatus, a fish logging device apparatus configured for gathering data on a fish caught by a user using a digital tape measure and digital weight scale coupled to the fish logging device apparatus, a fish logging device application installed on user smart phone for uploading gathered data stored on the fish logging device apparatus, wherein the fish logging device application is configured for uploading and downloading gathered data with a fish logging device server cloud, and a one touch selfie button coupled to the fish logging device apparatus to activate a user smart phone to take a photo of the fish caught.

In another embodiment, the device includes a near-field transceiver coupled to the fish logging device apparatus configured for transmitting a signal when activated using the fish logging device apparatus selfie button for triggering the user smart phone camera. In another embodiment, the includes a digital memory device coupled to the fish logging device apparatus to store the gathered data on a fish caught by a user for displaying on a data display screen coupled to the fish logging device apparatus. In another embodiment, the device includes a digital server used to create the fish logging device server cloud with a fish species database for processing a photo of the fish caught by the user to identify the fish species. In another embodiment, the device includes a database with type of fish, bait used, depth of water and fishing locations on the fish logging device server cloud, wherein the fish logging device server cloud can download automatically to the fish logging device application using the user smart phone current GPS location nearby fishing locations and fishing information related to that fishing location.

The foregoing has described the principles, embodiments and modes of operation of the embodiments. However, the embodiments should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
providing a fish logging device apparatus with a digital tape measure, digital weight scale and a digital memory device for gathering data on a fish caught by a user and for storing the gathered data on the digital memory device;
displaying the gathered data on a fish logging device apparatus data display screen;
providing a fish logging device apparatus safety fish lip gripper with serrated gripping jaws and a safety fish lip gripper finger grip activator for securing the fish to the fish logging device apparatus;
activating a fish logging device apparatus selfie button for triggering a fish logging device application installed on a user smart phone for operating the user smart phone camera for capturing a photo of the fish; and
downloading the gathered data using the fish logging device application and uploading the gathered data including the user smart phone fish logging device application gathered data to a fish logging device server cloud for storing, processing and downloading the gathered data.

2. The method of claim 1, wherein gathering data on a fish caught by a user includes a weight using the digital weight scale and a length of the fish using the digital tape measure.

3. The method of claim 1, further comprising a near-field transceiver coupled to the fish logging device apparatus configured for transmitting a signal when activated using the fish logging device apparatus selfie button for triggering the user smart phone camera.

4. The method of claim 1, further comprising a digital wherein gathering data on a fish caught by a user includes using the fish logging device application installed on user smart phone to capture a GPS location of where the fish was caught.

5. The method of claim 1, further comprising a digital server for creating the fish logging device server cloud configured for uploading and downloading the gathered data from and to the user smart phone fish logging device application.

6. The method of claim 1, wherein the fish logging device server cloud includes a database of fish species for processing the photo of the fish for automatically identifying the fish species and for downloading the fish species data to the fish logging device application.

7. The method of claim 1, further comprising using the user smart phone fish logging device application for downloading the gathered data for sharing with friends and family on social media.

8. The method of claim 1, further comprising uploading and downloading data interactively between the fish logging device application installed on user smart phone and the fish logging device server cloud wherein the fish logging device server cloud is automatically updating and storing for retrieval a database with phase of moon, barometric pressure conditions, sunny/cloudy/overcast forecasts, route maps to fishing locations, locations of where fish have been caught, and time of catch and transmitting requested data by a user using the fish logging device application.

9. The method of claim 1, further comprising uploading and downloading data interactively between the fish logging device application installed on user smart phone and the fish logging device server cloud wherein the fish logging device server cloud includes a database with type of fish, bait used, and depth of water and wherein data is auto searched and loaded to the fish logging device server cloud and data can be filtered for retrieval by date, weight, fish type, and location using the fish logging device application.

10. The method of claim 1, further comprising uploading and downloading data interactively between the fish logging device application installed on user smart phone and the fish logging device server cloud wherein the fish logging device server cloud includes a database with nearby fishing locations for transmitting nearby fishing locations automatically based on the user smart phone current GPS location to the user including displaying locations on the user smart phone for performing a search of nearby fishing locations for an area entered by the user on the user smart phone.

11. An apparatus, comprising:
a fish logging device configured for gathering data on fish caught by a user using a digital tape measure, a digital weight scale and a digital memory device coupled to the fish logging device;
a safety fish lip gripper with serrated gripping jaws and a safety fish lip gripper finger grip activator coupled to the fish logging device for securing a fish to the fish logging device;
a one touch selfie button coupled to the fish logging device and configured to activate a user smart phone for taking a photo of the fish caught;
a fish logging device application installed on a user smart phone and configured to download gathered data from the fish logging device digital memory device and upload and download the gathered data with a fish logging device server cloud; and
a fish logging device server cloud configured to gather data about fishing including data on a fish caught by a user and configured to interactively upload and download data with the fish logging device application installed on a user smart phone.

12. The apparatus of claim 11, further comprising a data display screen, handle, floatable case, and control buttons coupled to the fish logging device.

13. The apparatus of claim 11, wherein the fish logging device is configured for using the one touch selfie button to activate the fish logging device application installed on a user smart phone to trigger a camera to take a photo of the fish and weight and length of the fish displayed on the data display screen.

14. The apparatus of claim 11, wherein the fish logging device server cloud is configured for processing an uploaded photo of the fish using the fish logging device application installed on user smart phone to identify the fish species of a fish caught using a fish species database on the fish logging device server cloud.

15. The apparatus of claim 11, wherein the fish logging device server cloud is configured for uploading and downloading data interactively between the fish logging device application installed on user smart phone wherein the fish logging device server cloud includes a database with nearby fishing locations for transmitting nearby fishing locations automatically based on a user smart phone current GPS location to the user including displaying locations on the user smart phone with fish logging device application installed and for performing a search of nearby fishing locations for an area entered by the user on the user smart phone.

16. An apparatus, comprising:
a fish logging device with a safety fish lip gripper with serrated gripping jaws and a safety fish lip gripper finger grip activator to secure a fish to the fish logging device;
a fish logging device configured for gathering data on a fish caught by a user using a digital tape measure and digital weight scale coupled to the fish logging device;
a fish logging device application installed on user smart phone for uploading gathered data stored on the fish logging device;
wherein the fish logging device application is configured for uploading and downloading gathered data with a fish logging device server cloud; and
a one touch selfie button coupled to the fish logging device to activate a user smart phone to take a photo of the fish caught.

17. The apparatus of claim 16, further comprising a near-field transceiver coupled to the fish logging device configured for transmitting a signal when activated using the fish logging device selfie button for triggering the user smart phone camera.

18. The apparatus of claim 16, further comprising a digital memory device coupled to the fish logging device to store the gathered data on a fish caught by a user for displaying on a data display screen coupled to the fish logging device apparatus.

19. The apparatus of claim 16, further comprising a digital server used to create the fish logging device server cloud with a fish species database for processing a photo of the fish caught by the user to identify the fish species.

20. The apparatus of claim 16, further comprising a database with type of fish, bait used, depth of water and fishing locations on the fish logging device server cloud, wherein the fish logging device server cloud can download automatically to the fish logging device application using the user smart phone current GPS location nearby fishing locations and fishing information related to that fishing location.
